(19) United States
(12) Patent Application Publication
(10) Pub. No.: US 2012/0169685 A1
(43) Pub. Date: Jul. 5, 2012

(54) ELECTRICAL DEVICE WITH LIGHT CONDUIT SYSTEM

(75) Inventor: Teerapat Theerawong, Delray Beach, FL (US)

(73) Assignee: OPENPEAK INC., Boca Raton, FL (US)

(21) Appl. No.: 12/983,110

(22) Filed: Dec. 31, 2010

(51) Int. Cl. G09G 5/10; G01J 1/42

(52) U.S. Cl. 345/207; 250/227.11

(57) ABSTRACT

An electrical device includes a screen with an aperture formed therein. The device includes a light source, a light sensor and a light conduit. The light conduit is operatively positioned between the aperture on one side and the light source and light sensor on the other. When the light source is activated, some of the light energy emitted therefrom is received in the light conduit. This light energy can travel through the light conduit to the aperture, through which the light energy can exit the device, thereby providing notice to a user of some condition. Light energy received in the aperture from outside the device can enter the light conduit and pass therethrough to the light sensor. The brightness of the screen can be adjusted based on the amount of light energy received by the light sensor.

### FIELD

Embodiments relate in general to electrical devices and, more particularly, to electrical devices that include a light source and a light sensor.

### BACKGROUND

Portable communication devices are ubiquitous in modern society. Many of such portable communication devices include a light sensor, which receives light energy from outside the device. Based on the amount of ambient light detected by the light sensor, the brightness of a display of the portable communication device is adjusted to enhance the viewability of the display. Many portable communication devices also include one or more notification lights to provide notice to a user of some condition associated with the device, such as whether the device is activated.

The light sensor must be able to receive light energy from outside the device, and light emitted by the notification light must be viewable from outside the device. Accordingly, holes are provided in the device to allow for the passage of light into or out of the device and/or to accommodate the light sensor and the notification light or associated components. However, providing a plurality holes in the device is challenging because there is often little or no space available to include such holes. In addition, too many holes can detract from the overall aesthetic appearance of the device and can increase the chances that contaminants, such as dirt or water, can be introduced into the device. Moreover, as the quantity of holes increases, there is a resultant increase in the number of manufacturing steps and associated cost. Thus, there is a need for a system that can minimize such concerns.

### SUMMARY

One aspect of embodiments herein is directed to a system for an electrical device. The system includes a light source, a light sensor and a light conduit. The light source has a first operational mode in which the light source is activated. In such case, the light source emits light energy therefrom. The light source also has a second operational mode in which the light source is deactivated. As a result, substantially no light energy is emitted from the light source.

The light conduit has a first end and an opposite second end. The light conduit is operatively positioned relative to the light source such that at least a portion of the light energy emitted from the light source is received in the first end of the light conduit. The light conduit is operatively positioned relative to the light sensor. As a result, at least a portion of light energy received in the second end of the light conduit passes through the light conduit to the light sensor. In one embodiment, the first end of the light conduit can be substantially aligned with the light sensor. The light conduit is configured to permit the passage of light therethrough in a plurality of directions.

The light conduit can have a substantially solid body. Alternatively, the light conduit can include a first internal passage and a second internal passage. The first and second internal passages can extend generally from the first end to the second end of the light conduit. The first internal passage can be operatively positioned relative to the light source. As a result, at least a portion of the light energy emitted by the light source can be received in the first internal passage. The second internal passage can be operatively positioned relative to the light sensor. As a result, at least a portion of the light energy received in the second internal passage can be routed to the light sensor. In one embodiment, the first and second internal passages can be non-parallel to each other. In one instance, the first and second internal passages can merge proximate to the second end of the light conduit so as to form a common internal passage.

The system can further include a controller that is operatively connected to the light source and the light sensor. When the light source is in the first operational mode, the controller can be configured to one of (a) ignore electrical signals generated by the light sensor in response to light energy received thereby, (b) deactivate the light sensor, or (c) consider the increase in light intensity from the light source during the processing of the input from the light sensor. When the light source is in the second operational mode, the controller may not ignore the light sensor and/or may active the light sensor.

Another aspect of embodiments herein is directed to an electrical device. The device includes an outer component that has an inner surface and an outer surface. An aperture is formed in the device.

The device includes a light source. The light source has a first operational mode in which the light source is activated such that light energy is emitted therefrom. The light source has a second operational mode in which the light source is deactivated such that substantially no light energy is emitted from the light source. The system includes a light sensor. The light sensor is adapted to convert light energy received thereby into electrical signals.

The electrical device further includes a light conduit. The light conduit has a main body with an inner end and an outer end. In some instances, the light conduit can include a projection that extends from the main body. The light conduit can be a substantially solid body.

The light conduit is operatively positioned relative to the light source such that at least a portion of the light energy emitted from the light source is received in the inner end thereof. The light conduit is operatively positioned relative to the light sensor such that at least a portion of the light energy received in the outer end passes through the light conduit and to the light sensor. In one embodiment, the light sensor can be substantially aligned with the aperture. The light source can be offset from the aperture, or it can be substantially aligned with the aperture. In one embodiment, the outer end of the light conduit can be spaced from the outer component.

The light conduit is configured to permit the passage of light therethrough in a plurality of directions. In one embodiment, the light conduit can be made of a polycarbonate resin.

The device can further include a controller that is operatively connected to the light source and the light sensor. When the light source is in the first operational mode, the controller can be configured to ignore electrical signals generated by the light sensor. Alternatively, the controller can be configured to deactivate the light sensor when the light source is in the first operational mode. Still alternatively, the controller can process the input from the light sensor. However, during such processing, the controller can be configured to consider the increase in light intensity from the light source when the light source is in the first operational mode. When the light source is in the second operational mode, the controller can adjust a condition of the electrical device based at least in part on the electrical signals generated by the light sensor. For instance, the brightness of a display of the device can be adjusted.

The outer component can include a mask that is operatively connected to the inner surface and/or outer surface of the outer component. In one embodiment, the aperture can be defined by a hole formed in the mask. In another embodiment, the aperture can be defined by either a transparent region or a translucent region in the mask.

The device can further include a substrate. The light source and/or the light sensor can be operatively connected to the substrate. In one embodiment, the substrate can be a printed circuit board. In some instances, the light conduit may not be attached to the substrate. The light conduit may be spaced from the substrate, the light source and/or the light sensor.

Still another aspect of embodiments herein is directed to a method of operating an electrical device. The electrical device has a display. The device includes a light source, a light sensor and a light conduit operatively positioned relative to the light source and the light sensor. The device further includes a controller operatively connected to the light source, the light sensor and the display.

According to the method, the light source is activated such that light energy is emitted therefrom. The light source is deactivated such that light energy is substantially not emitted therefrom. The activation and deactivation of the light source can be performed by the controller. The light sensor converts light energy received thereby into electrical signals. When the light source is activated, the controller can ignore electrical signals generated by the light sensor, deactivate the light sensor, or consider the increase in light intensity from the light source during the processing of the input from the light sensor. When the light source is deactivated, the brightness of the display is adjusted based on electrical signals generated by the light sensor in response to light energy received thereby from outside the electrical device. Such adjusting can be performed by the controller.

### BRIEF DESCRIPTION OF THE DRAWINGS

FIG. 1 is a perspective view of a portion of an electrical device, showing an aperture in the electrical device.

FIG. 2 is a side elevation cross-sectional view of a portion of the electrical device.

FIG. 3 is a plan view of a light sensor and a light source operatively connected to a substrate, showing the light sensor being substantially aligned with the aperture in the electrical device and the light source being offset from the aperture.

FIG. 4 is a plan view of a light sensor and a light source operatively connected to a substrate, showing the light sensor and the light source being substantially aligned with the aperture in the electrical device.

FIG. 5 is a perspective view of a light conduit.

FIG. 6 is a cross-sectional view of a light conduit, showing a light conduit having a first internal passage and a second internal passage therein.

FIG. 7 is a cross-sectional view of a light conduit having a tubular configuration.

FIG. 8 is a view of a portion of the electrical device, showing the light conduit being operatively attached to a portion of the electrical device.

FIG. 9 is a plan view of a light sensor and a light source operatively connected to a substrate, showing the light sensor and the light source being operatively positioned with respect to an inner end of the light conduit.

FIG. 10 is a diagrammatic view of a system for ignoring the signals from a light sensor when a light source is activated.

### DETAILED DESCRIPTION

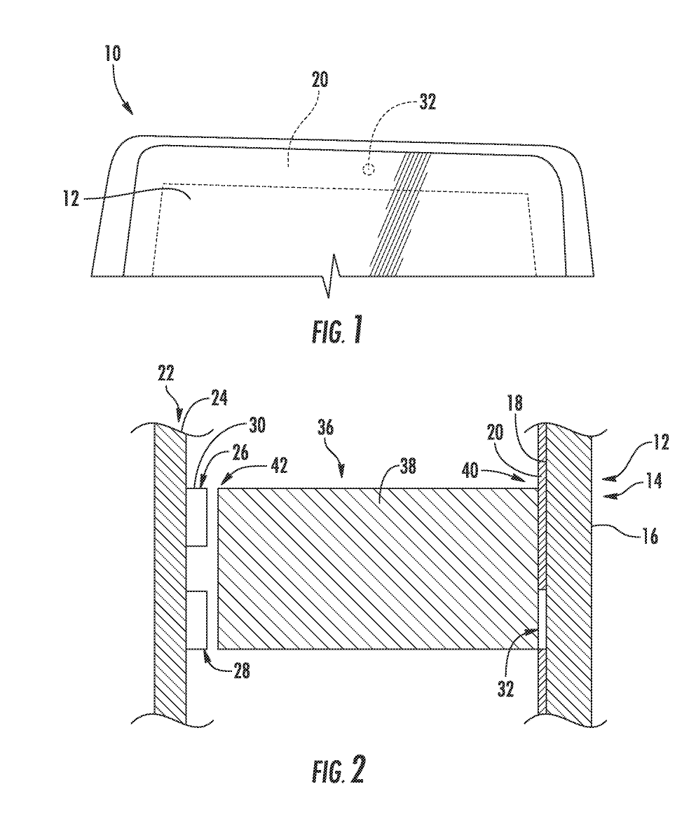

Arrangements described herein relate to a light conduit system for an electrical device. Detailed embodiments are disclosed herein; however, it is to be understood that the disclosed embodiments are intended only as exemplary. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of the invention. Arrangements are shown in FIGS. 1-10, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

Referring to FIG. 1, a portion of an electrical device 10 is shown. “Electrical device” means any device that is at least partially powered by electrical energy. The electrical device 10 can be any suitable device including, for example, a cellular telephone, a smart phone, a cordless telephone, a personal digital assistant (“PDA”), a tablet computer, a digital reader, a handheld device having wireless connection capability, a Station (“STA”), or other suitable processing device connected to a wireless modem, a computer (e.g., a laptop), a portable communication device, a portable computing device, an entertainment device (e.g., a music or video device, or a satellite radio), a global positioning system device, or any other suitable device that is configured to communicate via a wireless or wired medium a desktop computer, a digital audio player (e.g., MP3 player), an e-book reader, a camera or a game console. Embodiments described herein can be implemented into any suitable electrical device, including any of those listed above. The electrical device 10 may have a display 12, which can be any suitable type of display, including, for example, a liquid crystal display (LCD), plasma display panel (PDP), a light emitting diode (LED) display, or liquid crystal on silicon (LCoS).

FIG. 2 shows a side elevation cross-sectional view of a portion of the electrical device 10. The electrical device 10 can include an outer component 14. In one embodiment, the outer component 14 can form at least a portion of the display 12 of the electrical device 10. The outer component 14 can have an outer surface 16 and an inner surface 18. The outer component 14 can be made of any suitable material, including, for example, plastic or glass. The outer component 14 can have any suitable form. For example, at least one of the inner surface 18 and the outer surface 16 of the outer component 14 can be generally planar. Alternatively, at least a portion the inner surface 18 and/or the outer surface 16 of the outer component 14 can be curved or otherwise non-planar across the entire surface or in at least one or more localized areas. At least a portion of the outer component 14 can be transparent or translucent.

A mask 20 can applied to the outer surface 16 and/or the inner surface 18 of the outer component 14. For instance, the mask 20 can be operatively connected to the outer surface 16 and/or the inner surface 18 of the outer component 14. The term “operatively connected,” as used herein, can include direct or indirect connections, including connections without direct physical contact. The mask 20 may form at least a portion of the outer surface 16 and/or the inner surface 18 of the outer component 14.

The mask 20 can be made of any suitable type of material and can be provided in any suitable form. For example, the mask 20 can be a paint, tape, film, glaze, plastic, polymer, paper, plating and/or adhesive. The mask 20 may be provided in a form that can be sprayed onto the outer surface 16 and/or the inner surface 18 of the outer component 14. The mask 20 can be opaque or translucent. In one embodiment, the mask 20 can be formed by treating the outer surface 16 and/or the inner surface 18 of the outer component 14, such as by sandblasting or acid etching. The mask 20 can serve at least an aesthetic function.

Referring to FIG. 2, the electrical device 10 can include a substrate 22. The substrate 22 can be located within the electrical device 10. As an example, the substrate 22 can be a printed circuit board 24. A light source 26 and/or a light sensor 28 can be operatively connected to the substrate 22. In one embodiment, the light source 26 and the light sensor 28 can be mounted directly on the substrate 22. The light source 26 and the light sensor 28 can be located proximate to each other, although not necessarily. In fact, the light source 26 and the light sensor 28 can have any suitable spatial relationship between them.

The light source 26 can be at least partially electrically powered. The light source 26 can be operative connected to receive electrical energy from a suitable source of electrical energy (not shown). The light source 26 can generate or emit any type of light. In one embodiment, the light source 26 can be one or more light emitting diodes (LEDs) 30. Embodiments are not limited to LEDs, as any suitable light source can be used. The light source 26 can emit light energy with any suitable characteristics, including both visible or non-visible wavelengths.

The light source 26 can have one or more operational modes. For instance, the light source 26 can have a first operational mode, in which the light source 26 activated. In such case, light energy is emitted from the light source 26. The light source 26 can also have a second operational mode, in which the light source 26 is deactivated. In such case, light energy is substantially not emitted from the light source 26. “Substantially not emitted” includes instances in which no light energy is emitted from the light source 26 as well as instances in which a minimal amount of light energy is emitted from the light source 26 such that it has a negligible effect or no effect on the operation of the light sensor 28.

The light source 26 can be operated to alternate between the first and second operational modes so as to appear as a flashing (or solid) light to a user, thereby notifying the user of a condition or event or to provide a warning. For instance, the light source 26 may alternate between the first and second operational modes to indicate that the electrical device 10 is activated, the battery is low, a missed call, an incoming call, a new message, just to name a few possibilities.

As noted above, the electrical device 10 can also include a light sensor 28. The light sensor 28 can be any component or group of components capable of receiving light and converting the received light into electrical signals. Examples of suitable light sensors 28 include photodiodes, photodetectors, photosensors, optical detectors, photoresistors or light dependent resistors (LDR), photovoltaic cells, phototransistors or phototubes containing a photocathode.

The electrical device 10 can include an aperture 32 (FIGS. 1, 2 and 6) to allow the passage of light energy through the outer component 14. The aperture 32 can be formed in the electrical device 10 in any suitable manner. In one embodiment, the aperture 32 can be a hole physically formed in the outer component 14. In another embodiment, the aperture 32 can be formed in the mask 20, such as by a hole in the mask 20 as is shown in FIG. 2. Alternatively, the aperture 32 can be formed by a region 33 in which the mask 20 is transparent or possibly translucent, as is shown in FIG. 6. The aperture 32 can have any suitable size, shape and configuration. In one embodiment, the aperture 32 can be substantially circular. In some instances, there may be additional components within the electrical device 10, such as a frame 34 (FIG. 6). In such case, the frame 34 or other component can be configured so as not to obstruct the aperture 32 formed in the mask 20 and/or in the outer component 14.

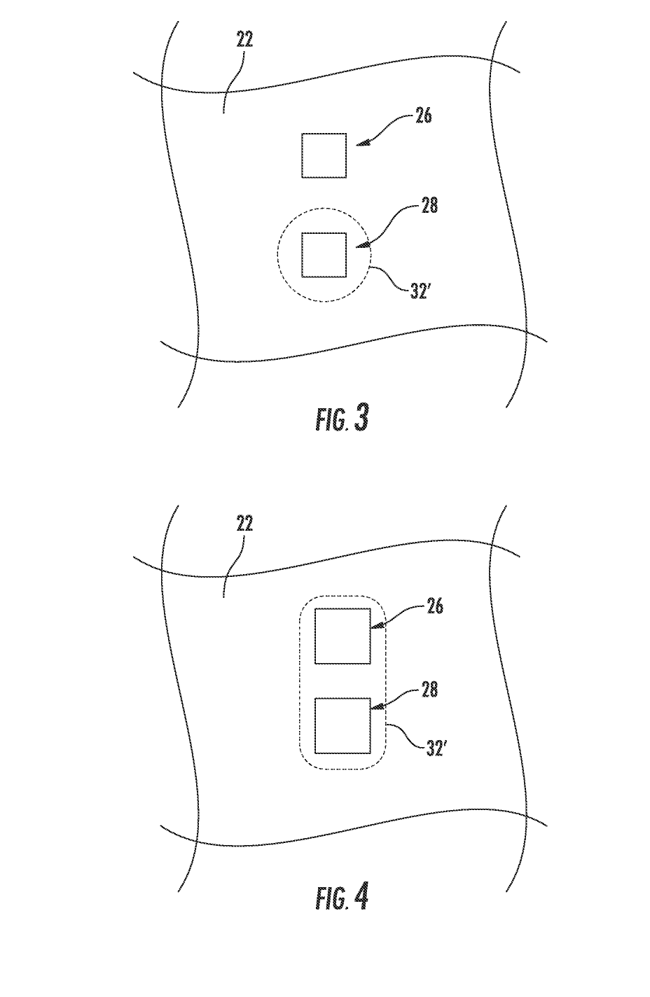

The aperture 32 can be operatively positioned with respect to the light source 26 and/or the light sensor 28. In one embodiment, the aperture 32 can be substantially aligned with the light sensor 28. “Substantially aligned” means that if an imaginary projection 32′ of the aperture 32 were superimposed onto the light sensor 28 and/or the substrate 22, then at least a portion of the light sensor 28 would overlap the imaginary projection 32′ of the aperture 32, as is shown in FIG. 3. In one embodiment, a majority of the light sensor 28 can overlap the imaginary projection 32′ of the aperture 32. In still another embodiment, the light sensor 28 can be located entirely within the imaginary projection 32′ of the aperture 32. In still another embodiment, the imaginary projection 32′ of the aperture 32 can be located entirely within the light sensor 28. In one embodiment, the axis (not shown) of the aperture 32 can pass through the light sensor 28.

The light source 26 can be offset from the aperture 32. “Offset” means that the imaginary projection 32′ of the aperture 32 does not overlap the light source 26, as is shown in FIG. 3. However, in some instances, the aperture 32 may be configured such that it is substantially aligned with both the light sensor 28 and the light source 26. In such case, if the imaginary projection 32′ of the aperture 32 were superimposed onto the light sensor 28, the light source 26 and/or the substrate 22, then the imaginary projection 32′ of the aperture 32 would overlap at least a portion of the light sensor 28 as well as at least a portion of the light source 26, as is shown in FIG. 4. In one embodiment, both the light sensor 28 and the light source 26 can be located entirely within the imaginary projection 32′ of the aperture 32. In some instances, the light sensor 28 may be offset from the aperture, and the light source 26 can be located at least partially within the imaginary projection 32′ of the aperture 32.

It should be noted that, in some instances, there can be a plurality of light sources 26 (not shown). In such case, at least one of the light sources 26 can be substantially aligned with the imaginary projection 32′ of the aperture 32. At least one of the plurality of light sources 26 can be offset from the imaginary projection 32′ of the aperture 32. A plurality of light sources 26 may be provided with each light source 26 emitting light with a different characteristic from the other light sources 26. For instance, the plurality of light sources 26 can each emit a different color of light. Each color can signify a different event, condition or warning.

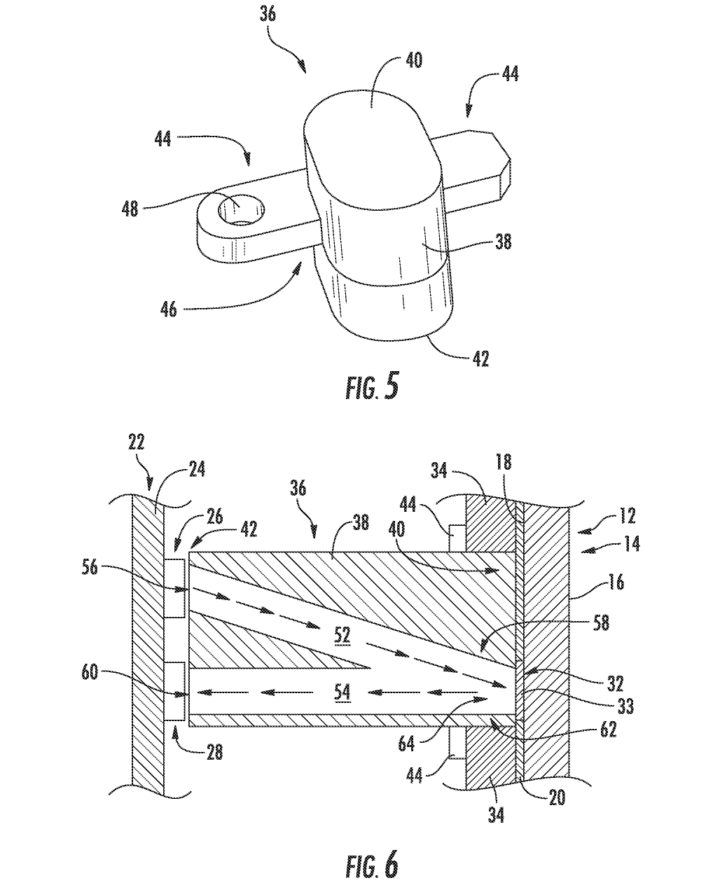

The electrical device 10 can also include a light conduit 36. A “light conduit” is any structure that allows the passage of light energy therethrough in one or more directions and with minimal absorption of the light energy passing therethrough. The light conduit 36 can have any suitable conformation. One example is shown in FIG. 5. In such case, the light conduit 36 can have a main body 38. The main body 38 can have any suitable conformation. In one embodiment, the main body 38 can have a generally oval cross-sectional shape, but other cross-sectional shapes are possible, including circular, triangular, rectangular, trapezoidal, and polygonal, just to name a few possibilities. The cross-sectional size and shape of the main body 38 can be substantially uniform, or at least one of the cross-sectional size and shape of the main body 38 can vary along at least a portion of the length of the main body 38. The light conduit 36 can have an outer end 40 and an inner end 42. The terms “inner” and “outer” are used to indicate the relative position of each end to the light sensor 28.

The light conduit 36 can be operatively positioned between the light sensor 28 and light source 26 on one hand and the aperture 32 on the other hand, as is shown in FIGS. 2 and 6. The light conduit 36 can be configured to facilitate its attachment within the electrical device 10. For instance, the light conduit 36 can include one or more projections 44 that extend from the main body 38, as is shown in FIG. 5. The projections 44 can have any suitable size and shape. In the case of a plurality of projections 44, the projections 44 can be similar to each other. Alternatively, at least one of the projections 44 can differ from the other projections 44 in one or more respects, including, for example, in size, shape, features and/or position. The one or more projections 44 can be unitary with the main body 38, or the projections 44 can be formed separately and subsequently attached to the main body 38.

The one or more projections 44 can be provided in any suitable location along the length of the main body 38. In the case of a plurality of projections 44, the projections 44 can be located at substantially the same point along the length of the main body 38. At least one of the plurality of projections 44 can be located at a different point along the length of the main body 38. In one embodiment, the projections 44 can be provided in a central region 46 of the main body 38, as is shown in FIG. 5.

In one embodiment, the projections 44 can extend generally laterally from the main body 38, as is shown in FIG. 5. The projections 44 can be configured for attachment to any suitable structure of the electrical device 10, such as the outer component 14 and/or the substrate 22. For example, at least one of the projections 44 can include a hole 48 extending therethrough. The hole 48 can have any suitable size, shape and configuration. In one embodiment, the projection 44 can be attached to the outer component 14, the mask 20, the substrate 22 and/or the frame 34 by a protrusion 50 (FIG. 8) that extends therefrom and into the hole 48. Alternatively, a fastener (not shown) can pass through the hole 48 for engagement with a suitable structure within the device 10, such as the frame 34, the outer component 14, the mask 20 and/or the substrate 22.

Again, the above-described arrangements are just a few examples of the various ways in which the light conduit 36 can be attached to the electrical device 10. Indeed, there are numerous other ways in which such attachment can be achieved, including, for example, by fasteners, mechanical engagement and/or adhesives. In one embodiment, the light conduit 36 can be attached at or near its outer end 40 to suitable structure, such as the frame 34, of the electrical device 10 by a plurality of projections 44, as is shown in FIG. 6. One of the projections 44 can have a hole 48 which receives a protrusion 50 from the frame 34, as is shown in FIG. 8. The other projection 44 can be attached to the frame 34 by an adhesive.

A portion of the main body 38 of the light conduit 36, including the outer end 40, can be received in an opening in the frame 34, as is shown in FIG. 6. Once the light conduit 36 is positioned, the outer end 40 can abut the inner surface 18 of the outer component 14. Alternatively, the outer end 40 can be spaced from the inner surface 18 of the outer component 14. The outer end 40 can be substantially the same size and/or shape as the aperture 32. Alternatively, the outer end 40 can be a different size and/or shape from the aperture 32.

In some instances, the light conduit 36 may be attached to the substrate 22 in any suitable manner, including any of the manners of attachment described herein. In some instances, the light conduit 36 is not attached to the substrate 22. At least a portion of the light conduit 36, such as the inner end 42, may directly contact the substrate 22, the light sensor 28 and/or the light source 26. In some embodiments, the light conduit 36 can be spaced from the substrate 22, the light sensor 28 and/or the light source 26.

The light conduit 36 can be operatively positioned with respect to the light source 26, the light sensor 28 and/or aperture 32. “Operatively positioned” means that the light conduit 36 is positioned such that at least a portion of the light energy received in the aperture 32 from outside the electrical device 10 is received in the light conduit 36 such that it can travel therethrough to the light sensor 28. “Operatively positioned” can also mean that the light conduit 36 is positioned such that at least a portion of the light energy emitted from the light source 26 is received in the light conduit 36, such as in the inner end 42 thereof.

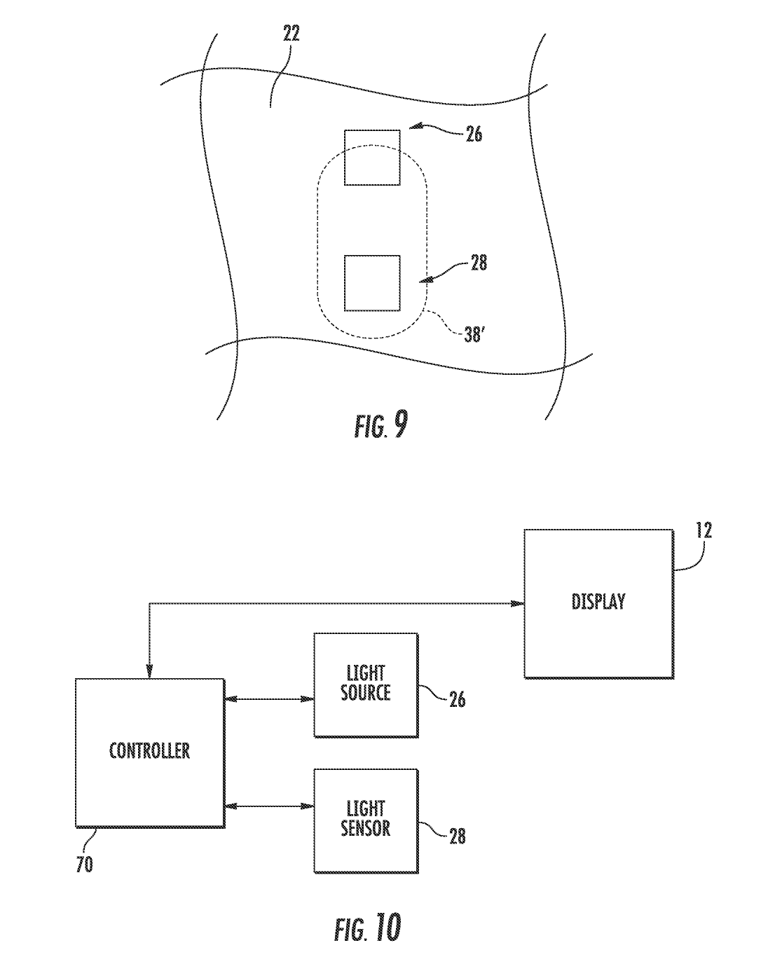

In one embodiment, the inner end 42 of the light conduit 36 can be substantially aligned with the light sensor 28 and/or the light source 26. Referring to FIG. 9, “substantially aligned” means that when an imaginary image 38′ of the main body 38 of the light conduit 36 is superimposed onto the substrate 22, the light sensor 28 and/or the light source 26, the light source 26 and the light sensor 28 can at least partially overlap the imaginary image 38′ of the main body 38. In one embodiment, both the light sensor 28 and the light source 26 can be located entirely within the imaginary projection 38′ of the main body 38.

The light conduit 36 can be made of any suitable material. The light conduit 36 can facilitate the passage of at least a portion of light energy received in the aperture 32 from outside the electrical device 10 to the light sensor 28. The light conduit 36 can also facilitate the passage of at least a portion of light energy from the light source 26 to the aperture 32. Thus, the light conduit 36 can be made of a material that can allow the passage of light energy therethrough in a plurality of directions, including generally from the inner end 42 to the outer end 40 as well as generally from the outer end 40 to the inner end 42. The material can be selected to provide the desired characteristics, such as diffusion and/or transmittance. In one embodiment, the material of the light conduit 36 can be selected to minimize the amount of light energy that is absorbed as the light energy that passes therethrough. In one embodiment, the light conduit 36 can be made of a polycarbonate resin. For instance, the light conduit 36 can be made of Lexan 9945A polycarbonate (PC) resin, which is available from SABIC Innovative Plastics, Pittsfield, Mass. The light conduit 36 can be made of any suitable light conducting material.

The light conduit 36 can be a substantially solid body; that is, the light conduit 36 may not have any internal passages formed therein, as is shown in FIG. 2. A substantially solid body may include voids formed during the manufacture of the light conduit 36. However, in some instances, the light conduit 36 may have one or more internal passages that extend through the main body 38 generally from the inner end 42 to the outer end 40. In one embodiment, as is shown in FIG. 6, the light conduit 36 can include a first internal passage 52 and a second internal passage 54. The first internal passage 52 can include a first end 56 and a second end 58. Similarly, the second internal passage 54 can include a first end 60 and a second end 62.

The first and second internal passages 52, 54 can have any suitable size and shape. The first and second internal passages 52, 54 may be substantially identical to each other, or they can be different from each other in one or more respects, such as in size and/or shape. The first internal passage 52 and the second internal passage 54 may be non-parallel to each other. In one embodiment, the first and second internal passages 52, 54 can merge so as to form a common second end 64, as is shown in FIG. 6.

The light conduit 36 can be operatively positioned such that the second internal passage 54 is operatively positioned with respect to the light sensor 28. In such case, at least a portion of the light sensor 28 may be received in the first end 60 of the second internal passage 54. Alternatively, the light sensor 28 may be spaced from the first end 60 of the second internal passage 54, as is shown in FIG. 6. The first internal passage 52 can be operatively positioned with respect to the light source 26. In such case, at least a portion of the light source 26 can be received in the first end 56 of the first internal passage 56. Alternatively, the light source 26 may be spaced from the first end 56 of the first internal passage 52, as is shown in FIG. 6. The first and second internal passages 52, 54 may be configured to facilitate the passage of light energy therethrough. For instance, the passages 52, 54 can be coated with reflective material and/or a material that can minimize the transmission of light energy into the rest of the main body 38 of the light conduit 36. Alternatively, the material of the light conduit 36 itself may facilitate the passage of light energy through the first and second internal passages 52, 54.

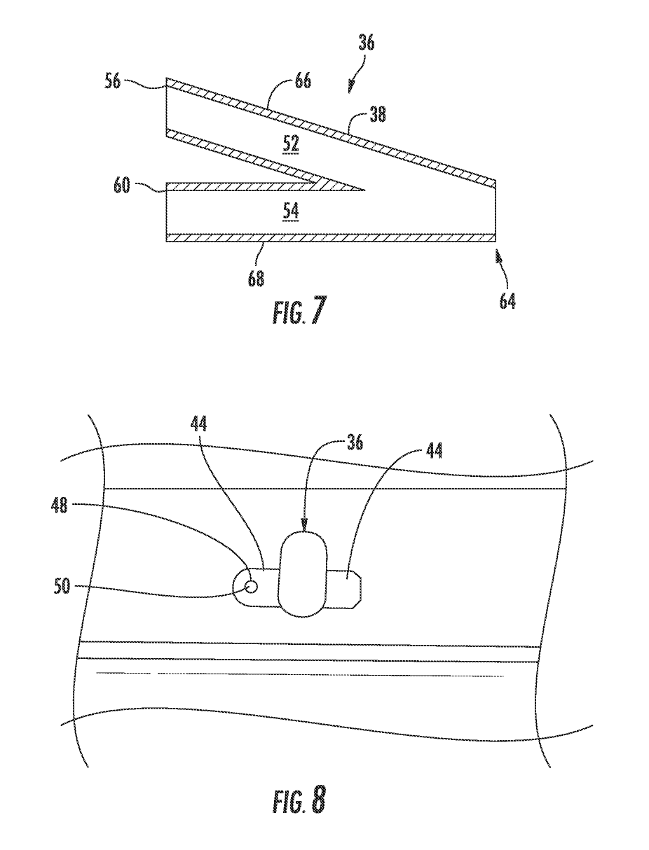

In some instances, the light conduit 36 can be a tubular like piece with a first branch 66 and a second branch 68, as is shown in FIG. 7. In such case, the light conduit 36 can be generally v-shaped. The first branch can define the first internal passage 52, and the second branch can define the second internal passage 54. The above discussion of the first and second internal passages 52, 54 in connection with FIG. 6 applies equally here.

Now that the individual components of various embodiments have been described, one manner of the operation of the system will now be described. It will be understood that the following description is merely exemplary. During operation of the electrical device 10, the light source 26 can cycle between the first and second operational modes to alert a user to a condition (i.e., the electrical device is active) or an event (i.e., missed call or incoming call) or to provide a warning (i.e., low battery) to the user. When the light source 26 is in the first operational mode, a least a portion of the light energy emitted by the light source 26 can enter the light conduit 36 through at least the inner end 42 thereof. The light energy can travel through the main body 38 of the light conduit 36 generally from the inner end 42 toward the outer end 40 thereof. In at least some instances, light energy emitted from the light source 26 can travel from the light source 26 in a generally conical path. As a result, the light energy can have an angular component to its direction of travel. Thus, it will be appreciated that even if the light source 26 is offset from the aperture 32, the light energy emitted therefrom the light source 26 can still enter and travel through the light conduit 36.

As the light energy travels through the light conduit 36, it will be appreciated that there can be sufficient transmittance and diffusion of the light energy due at least in part to the material of the light conduit 36, such that at least a portion of the light energy that enters the light conduit 36 can exit the light conduit 36 through the outer end 40 thereof. After exiting the outer end 40, at least a portion of light energy can then pass through the aperture 32 such that it is visible to a user of the electronic device 10 or to some other component. Thus, the user (or component) can be apprised of a condition, event and/or warning.

As noted previously, the light source 26 may cycle between the first and second operational modes. During the second operational mode, light energy is not emitted by the light source 26. However, regardless of the operational mode of the light source 26, light energy from outside the electrical device 10 can be received in the aperture 32. At least a portion of such light energy can enter the light conduit 36 through the outer end 40 thereof. At least a portion of this light energy can travel through the main body 38 of the light conduit 36 and exit therefrom and impinge on the light sensor 28.

The electrical device 10 can be configured so that one or more conditions of the electrical device 10 can be automatically adjusted based on the amount of light energy received by the light sensor 28. For instance, the brightness of the display 12 can be automatically adjusted in any known manner. However, it will be appreciated that, because the light source 26 and the light sensor 28 share the same light conduit 36, the light sensor 28 may sense a greater amount of light than ambient light due to the additional light energy from the light source 26, thereby potentially leading to improper and unwanted adjustments being made to the brightness display 12. To avoid such a possibility, the system can be configured so that when the light source 26 is in the first operational mode, the light energy received by the light sensor 28 is ignored. That is, adjustments to one or more conditions to the electrical device 10, such as the brightness of the display 12, are not made based on the amount of light energy received by the light sensor 28 during the first operation mode of the light source 26, thereby minimizing the possibility of an improper adjustment.

Light energy from the light sensor 28 can be ignored in any suitable way. For instance, in one implementation, electrical signals generated by the light sensor 28 can be ignored or otherwise filtered and thus effectively ignored. Alternatively, the light sensor 28 can be deactivated while the light source 26 is in the first operational mode. When the light source 26 switches to the second operational mode, the light sensor 28 can be activated. It will be appreciated that, since the light source 28 is deactivated, the light energy received by the light sensor 28 will be from substantially outside the electrical device 10. As a result, adjustments to the display 12 can be made based on suitable information.

In another arrangement, the amount of light “noise” generated by the light source 26 in the first operational mode can be taken into account when measuring ambient light levels received at the light sensor 28. In particular, the amount of light generated by the light source 26 in the first operational mode can be measured, and the measured value(s) can be stored in a suitable location. When the input from the light sensor 28 is received when the light source 26 is in the first operational mode, the increase in light intensity from the light source 26 can be considered during the processing of the input from the light sensor 28. This process can permit the adjustments that were previously described to be made at virtually any time, even if the light source 26 is emitting light.

In some implementations, a controller 70 can be operatively connected the light source 26 and/or the light sensor 28, as is shown in FIG. 10. The controller 70 can be comprised of any suitable combination of hardware and/or software. While FIG. 10 shows an embodiment in which a single controller is operatively connected to the light source 26 and the light sensor 28, it will be understood that embodiments are not limited to such an arrangement. For instance, there can be a plurality of controllers 70. For example, there can be one controller operatively associated with the light source and a separate controller associated with the light sensor 28. In such case, the plurality of controllers may be operatively connected to each other.

The controller 70 can be operatively connected to selectively activate or deactivate the light source 28 in any suitable manner. The controller 70 can also be operatively connected to selectively activate or deactivate the light sensor 28 in any suitable manner, including based on the operational status of the light source 26. The controller 70 can be operatively connected to selectively ignore or process the signals generated by the light sensor 28 in any of the manners described above.

It will be appreciated that embodiments described herein can facilitate the use of a single aperture 32 for at least one light sensor 28 and at least one light source 26. As a result, fewer apertures are needed in the electrical device 10, which can improve the visual appearance of the electrical device. Because there are fewer apertures, space concerns are avoided and fewer manufacturing steps may be required, potentially providing some cost savings. Moreover, by providing a light conduit system as described herein, the one or more light sources 26 can be offset from the aperture 32, yet at least some of the light energy therefrom can nonetheless exit the device 10 through the aperture 32. As a result, smaller aperture sizes may be possible, which can further enhance the aesthetic appearance of the electrical device 10. Fewer openings for contaminants to enter can also be realized with this design.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

Moreover, as used herein, ordinal terms (e.g. first, second, third, fourth, fifth, sixth, seventh, eighth, ninth, tenth, and so on) distinguish one message, signal, item, object, device, system, apparatus, step, process, or the like from another message, signal, item, object, device, system, apparatus, step, process, or the like. Thus, an ordinal term used herein need not indicate a specific position in an ordinal series. For example, a process identified as a “second process” may occur before a process identified as a “first process.” Further, one or more processes may occur between a first process and a second process.

Aspects described herein can be embodied in other forms and combinations without departing from the spirit or essential attributes thereof. Thus, it will of course be understood that embodiments are not limited to the specific details described herein, which are given by way of example only, and that various modifications and alterations are possible within the scope of the following claims.

What is claimed is:

1. A system for an electrical device comprising:
a light source having a first operational mode in which the light source is activated, whereby the light source emits light energy therefrom, and a second operational mode in which the light source is deactivated, whereby light energy is substantially not emitted from the light source;
a light sensor; and
a light conduit having a first end and an opposite second end, the light conduit being operatively positioned relative to the light source such that at least a portion of the light energy emitted from the light source is received in the first end of the light conduit, the light conduit being operatively positioned relative to the light sensor such that at least a portion of the light energy received in the second end passes through the light conduit to the light sensor, the light conduit being configured to permit the passage of light therethrough in a plurality of directions.

2. The system of claim 1, wherein the light conduit has a substantially solid body.

3. The system of claim 1, wherein the light conduit includes a first internal passage and a second internal passage that extend generally from the first end to the second end, wherein the first internal passage is operatively positioned relative to the light source, whereby at least a portion of the light energy emitted by the light source is received in the first internal passage, and wherein the second internal passage is operatively positioned relative to the light sensor, whereby at least a portion of the light energy received in the second internal passage is supplied to the light sensor.

4. The system of claim 3, wherein the first and second internal passages are non-parallel to each other such that the first and second internal passages merge proximate to the second end of the light conduit so as to form a common internal passage.

5. The system of claim 1, wherein the first end of the light conduit is substantially aligned with the light sensor.

6. The system of claim 1, further including a controller operatively connected to the light source and the light sensor, wherein, when the light source is in the first operational mode, the controller is configured to one of (a) ignore electrical signals generated by the light sensor in response to light energy received thereby, (b) deactivate the light sensor, or (c) consider the increase in light intensity from the light source during the processing of the input from the light sensor.

7. An electrical device comprising:
an outer component having an inner surface and an outer surface, an aperture being formed in the electrical device;
a light source having a first operational mode in which the light source is activated, whereby the light source emits light energy therefrom, and a second operational mode in which the light source is deactivated, whereby light energy is substantially not emitted from the light source;
a light sensor adapted to convert light energy received thereby into electrical signals; and
a light conduit having a main body with an inner end and an outer end, the light conduit being operatively positioned relative to the light source such that at least a portion of the light energy emitted from the light source is received in the inner end, the light conduit being operatively positioned relative to the light sensor such that at least a portion of the light energy received in the outer end passes through the light conduit to the light sensor, the light conduit being configured to permit the passage of light therethrough in a plurality of directions.

8. The device of claim 7, wherein the light sensor is substantially aligned with the aperture.

9. The device of claim 8, wherein the light source is offset from the aperture.

10. The device of claim 7, further including a controller operatively connected to the light source and the light sensor, wherein, when the light source is in the first operational mode, the controller is configured to one of (a) ignore electrical signals generated by the light sensor, (b) deactivate the light sensor, or (c) consider the increase in light intensity from the light source during the processing of the input from the light sensor.

11. The device of claim 10, wherein, when the light source is in the second operational mode, the controller adjusts a condition of the electrical device based at least in part on the electrical signals from the light sensor.

12. The device of claim 7, wherein the outer component includes a mask operatively connected to at least one of the inner and outer surface thereof, wherein the aperture is defined by a hole formed in the mask.

13. The device of claim 7, wherein the outer component includes a mask operatively connected to at least one of the inner and outer surface thereof, wherein the aperture is defined by one of a transparent region or a translucent region in the mask.

14. The device of claim 7, wherein the outer end of the light conduit is spaced from the outer component.

15. The device of claim 7, wherein the light conduit includes a projection extending from the main body thereof.

16. The device of claim 7, further including a substrate, wherein the light source and the light sensor are operatively connected to the substrate.

17. The device of claim 16, wherein the substrate is a printed circuit board.

18. The device of claim 16, wherein the light conduit is not attached to the substrate.

19. The device of claim 7, wherein the light conduit is a substantially solid body.

20. A method of operating an electrical device having a display, the device including a light source and a light sensor, the device further including a light conduit operatively positioned relative to the light source and the light sensor, the device further including a controller operatively connected to the light source, the light sensor and the display, the method comprising the steps of:
activating the light source such that light energy is emitted therefrom;
deactivating the light source such that light energy is substantially not emitted therefrom;
via the light sensor, converting light energy received by the light sensor into electrical signals; and
wherein, during the step of activating the light source, the controller one of (a) ignores electrical signals generated by the light sensor, (b) deactivates the light sensor, or (c) considers the increase in light intensity from the light source during the processing of electrical signals from the light sensor; and
adjusting the brightness of the display based on electrical signals generated by the light sensor.
